(19) United States
(12) Patent Application Publication
(10) Pub. No.: US 2025/0187401 A1
(43) Pub. Date: Jun. 12, 2025

(54) EXTRACTOR GRILLE DEVICE FOR A VEHICLE

(71) Applicants: HYUNDAI MOTOR COMPANY, Seoul (KR); KIA CORPORATION, Seoul (KR); ITW EF & C Korea LLC., Incheon (KR)

(72) Inventors: Bong-Kyung Son, Ulsan (KR); Myung-Hun Kang, Gwangmyeong-si (KR); Dong-Won Yeon, Hwaseong-si (KR); Chang-Woo Ryu, Hwaseong-si (KR); Keong-No Kim, Incheon (KR)

(73) Assignees: HYUNDAI MOTOR COMPANY, Seoul (KR); KIA CORPORATION, Seoul (KR); ITW EF & C Korea LLC., Incheon (KR)

(21) Appl. No.: 18/625,992

(22) Filed: Apr. 3, 2024

(30) Foreign Application Priority Data
Dec. 8, 2023 (KR) 10-2023-0177573

(51) Int. Cl. B60H 1/24

(52) U.S. Cl. CPC B60H 1/249

(57) ABSTRACT

An extractor grille device for a vehicle, which is mounted in a vehicle and used to discharge air in the vehicle to the outside. The extractor grille device includes: a grille housing mounted in the vehicle and having an opening portion, a valve coupled to the grille housing and configured to be rotatable about a hinge shaft and open or close the opening portion, and a noise reduction part coupled to and protruding from one surface of the grille housing around the opening portion so that the valve does not collide directly with the grille housing when the valve is opened or closed, thereby reducing a rattling noise of the valve that constitutes an extractor grille.

### CROSS-REFERENCE TO RELATED APPLICATION

This application claims priority to Korean Patent Application No. 10-2023-0177573, filed on Dec. 8, 2023, which is incorporated herein by reference in its entirety.

### BACKGROUND

### Technical Field

The present disclosure relates to an extractor grille device mounted in a vehicle, and more particularly, to a ventilation opening device.

### Description of Related Art

An air extractor grille for a vehicle refers to a ventilation opening mounted in a vehicle and used to discharge air in the vehicle to the outside. For example, the extractor grille is mounted at a rear side of the vehicle.

To this end, the extractor grille includes a housing mounted in the vehicle and having an opening portion communicating with the outside, and valves configured to open or close the opening portion of the housing.

However, when the vehicle travels, the valve may vibrate and create a rattling noise, and the rattling noise may cause discomfort for a passenger seated in a rear seat.

The above information disclosed in the related art is provided only to enhance understanding of the background of the present disclosure and therefore it may contain information that does not form the related art that is already known to a person of ordinary skill in the art.

### SUMMARY

Accordingly, an object of the present disclosure considering the above point is to provide an extractor grille device capable of reducing a rattling noise caused by a valve that constitutes an extractor grille.

As an embodiment of the present disclosure, an extractor grille device for a vehicle is mounted in a vehicle and used to discharge air in the vehicle to the outside. The extractor grille device includes: a grille housing mounted in the vehicle and having an opening portion; and a valve coupled to the grille housing and configured to be rotatable about a hinge shaft and open or close the opening portion. The extractor grille device further includes: a noise reduction part coupled to and protruding from one surface of the grille housing around the opening portion so that the valve does not collide directly with the grille housing when the valve is opened or closed.

Further, the noise reduction part may be an elastic member having elasticity.

In addition, the elastic member may be foamed polyurethane foam (PU-foam).

In addition, an elastic member groove may be formed in one surface of the grille housing around the opening portion, and the elastic member may be inserted into the elastic member groove.

Further, the extractor grille device may further include: a rib part coupled to one surface of the grille housing around the elastic member and protruding from one surface of the grille housing.

In addition, the elastic member may be foamed polyurethane foam (PU-Foam), and holes may be formed at two opposite ends of the elastic member groove.

Meanwhile, the extractor grille device may further include: a valve opening guide part configured to restrict an opening angle of the valve when the valve is opened.

Further, the valve opening guide part may include: a frame portion mounted inside the grille housing, formed in a height direction of the grille housing, and disposed forward of the valve; and a guide portion protruding from the frame portion toward the valve.

In this case, the guide portion may protrude to be inclined.

Further, the frame portion may be provided as a plurality of frame portions including a central frame portion corresponding to a central portion based on a width direction, and an outer frame portion formed between the central frame portion and an inner surface of the grille housing.

In addition, the guide portion may be provided as a plurality of guide portions. The plurality of guide portions includes: a central guide portion formed on the central frame portion; and an outer guide portion formed on the outer frame portion. In particular, protruding lengths of the plurality of guide portions may vary depending on distances from the central portion to the guide portions.

Further, the protruding length of the central guide portion may be longer than the protruding length of the outer guide portion.

In addition, the guide portion may be provided as a plurality of guide portions. The plurality of guide portions includes: a central guide portion formed on the central frame portion; and an outer guide portion formed on the outer frame portion. Distances between the plurality of guide portions and the valve may vary depending on distances from the central portion to the guide portions.

In one embodiment, a distance between the central guide portion and the valve may be shorter than a distance between the outer guide portion and the valve.

Specifically, the opening angle of the valve may be restricted by interference with the central guide portion when the valve is maximally opened.

As another embodiment, an extractor grille device for a vehicle is mounted in a vehicle and used to discharge air in the vehicle to the outside. The extractor grille device includes: a grille housing mounted in the vehicle and having an opening portion; and a valve coupled to the grille housing and configured to be rotatable about a hinge shaft and open or close the opening portion. The extractor grille device further includes: a valve opening guide part configured to restrict an opening angle of the valve when the valve is opened. The valve opening guide part includes: a frame portion mounted inside the grille housing, formed in a height direction of the grille housing, and disposed forward of the valve. The extractor grille device further includes a guide portion protruding from the frame portion toward the valve.

In one embodiment, the frame portion may be provided as a plurality of frame portions including a central frame portion corresponding to a central portion based on a width direction, and an outer frame portion formed between the central frame portion and an inner surface of the grille housing. In one embodiment, the guide portion is provided as a plurality of guide portions including a central guide portion formed on the central frame portion, and an outer guide portion formed on the outer frame portion. Distances between the plurality of guide portions and the valve may vary depending on distances from the central frame portion to the guide portions.

In addition, a distance between the central guide portion and the valve may be shorter than a distance between the outer guide portion and the valve.

Further, the opening angle of the valve may be restricted by interference with the central guide portion when the valve is maximally opened.

Meanwhile, the extractor grille device may further include: a noise reduction part coupled to and protruding from one surface of the grille housing around the opening portion so that the valve does not collide directly with the grille housing when the valve is opened or closed.

According to the extractor grille device of the present disclosure, the noise reduction part formed on the grille housing may reduce a noise occurring when the valve collides with the housing.

Further, the valve opening guide part restricts the opening angle of the valve, thereby reducing strength by which the valve collides with the grille housing. Therefore, the user and the rear seat passenger may be more comfortable.

### BRIEF DESCRIPTION OF THE DRAWINGS

In order that the disclosure may be well understood, there will now be described various forms thereof, given by way of example, reference being made to the accompanying drawings, in which:

FIG. 1 is views illustrating shapes of a front side of an extractor grille device in one embodiment of the present disclosure;

FIG. 2 shows a partial configuration of a front side of an extractor grille device in one embodiment of the present disclosure;

FIG. 3 is a view illustrating a cross-section taken along line A-A in FIG. 2;

FIG. 4 is a partially enlarged view of FIG. 1;

FIG. 5 is a partial perspective view of FIG. 4;

FIG. 6 is a view illustrating a cross-section taken along line B-B in FIG. 4;

FIG. 7 is a view illustrating an additional configuration of an extractor grille device in one embodiment of the present disclosure;

FIG. 8 is a view illustrating a partial shape of FIG. 7; and

FIG. 9 is a partially enlarged view of an extractor grille device in one embodiment of the present disclosure.

The drawings described herein are for illustration purposes only and are not intended to limit the scope of the present disclosure in any way.

### DETAILED DESCRIPTION

Hereinafter, embodiments of the present disclosure are described in detail with reference to the exemplary accompanying drawings, and since these embodiments, as examples, may be implemented in various different forms by those having ordinary skill in the art to which the present disclosure pertains, they are not limited to the embodiments described herein.

In order to sufficiently understand the present disclosure, advantages in operation of the present disclosure, and the object to be achieved by carrying out the present disclosure, reference needs to be made to the accompanying drawings for illustrating an exemplary embodiment of the present disclosure and contents disclosed in the accompanying drawings.

Further, in the description of the present disclosure, the repetitive descriptions of publicly-known related technologies are reduced or omitted when it is determined that the descriptions may unnecessarily obscure the subject matter of the present disclosure.

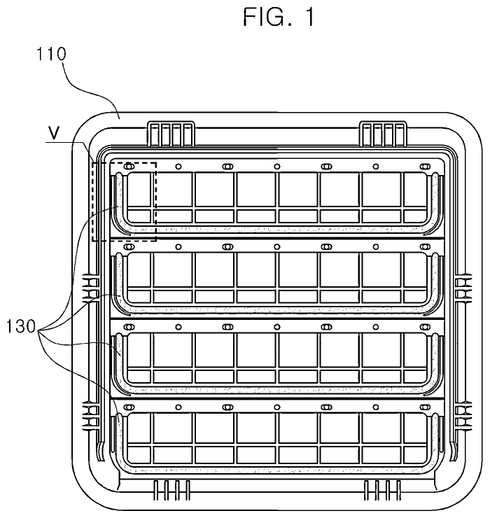

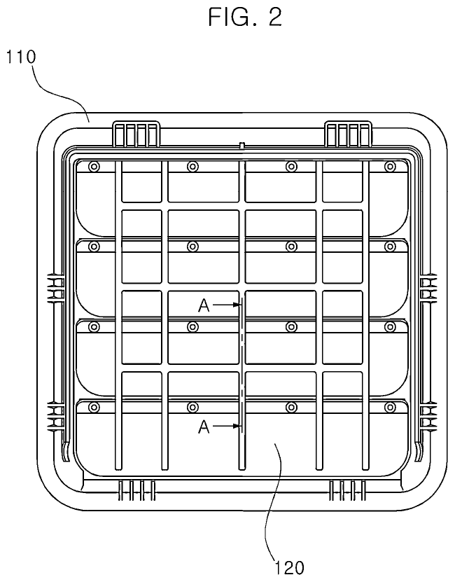

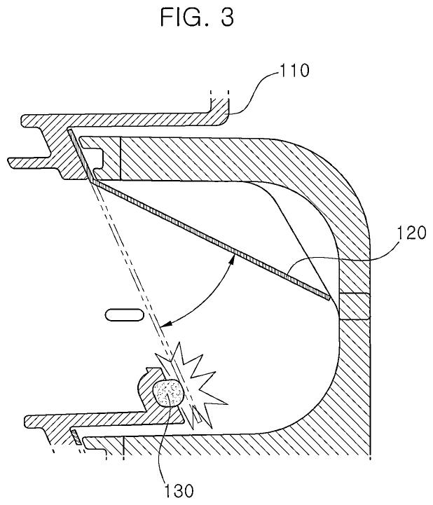

FIGS. 1 and 2 are views illustrating shapes of a front side of an extractor grille device in one embodiment of the present disclosure, and FIG. 3 is a view illustrating a cross-section taken along line A-A in FIG. 2.

Hereinafter, an extractor grille device for a vehicle according to an embodiment of the present disclosure is described with reference to FIGS. 1 to 3.

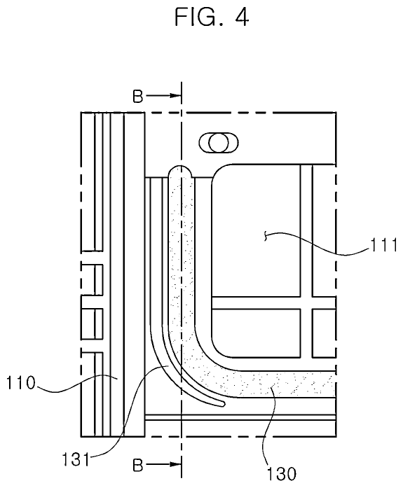

The present disclosure relates to an air extractor grille for a vehicle that is mounted in a vehicle, e.g., mounted at a rear side of the vehicle and used to discharge air in the vehicle to the outside. The extractor grille includes a grille housing 110 mounted in the vehicle and having an opening portion 111 (see FIG. 4) communicating with the outside, and valves 120 each having one end hingedly coupled to an inner surface of the grille housing 110 so that the valves 120 operate to open or close the opening portion 111 while rotating about hinge shafts. Further, the extractor grille may further include a separate drive means for rotating the valve 120.

The present disclosure is intended to reduce a noise (slap noise) caused by a rattling noise of the valve 120 when the vehicle travels. A noise reduction part is coupled to and protrudes from one surface of the grille housing 110 around the opening portion 111 to prevent the valve 120 from colliding directly with the grille housing 110. The noise reduction part may be an elastic member 130.

Further, the elastic member 130 may be foamed polyurethane foam (PU-foam).

As illustrated, the opening portion 111 may be divided into a plurality of opening portions by partition walls formed in the grille housing 110, and the elastic members 130 may be respectively attached to peripheries of the plurality of opening portions 111.

The configuration is described in more detail with reference to FIGS. 4 to 6. An elastic member groove 112 is formed in one surface of the grille housing around the opening portion 111, and the elastic member 130 is attached and inserted into the elastic member groove 112 by foaming.

In one embodiment, the valve 120 is not in contact with one surface of the grille housing 110 because of the elastic member 130. Therefore, a rib part 131, which is configured as another elastic member, may be attached to one surface of the grille housing around the elastic member groove 112 so as to protrude from the grille housing 110.

The application of the rib part 131 may improve watertightness performance and sealing performance.

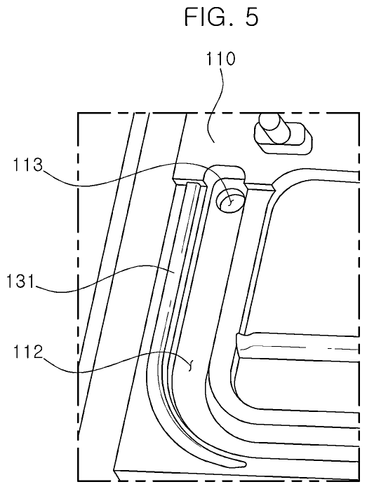

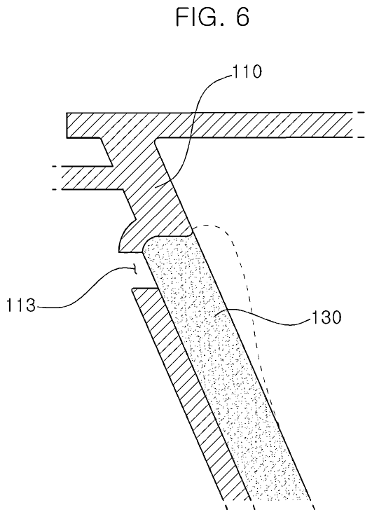

With reference to FIGS. 5 and 6, holes 113 may be formed at two opposite ends of the elastic member groove 112 and used to flatten the foamed polyurethane foam (PU-foam). As indicated by the dotted line in FIG. 6, an end of the elastic member 130 agglomerates and bulges and thus becomes in a convex state. However, because the hole 113 is applied, the elastic member 130 may have a flat shape, as illustrated.

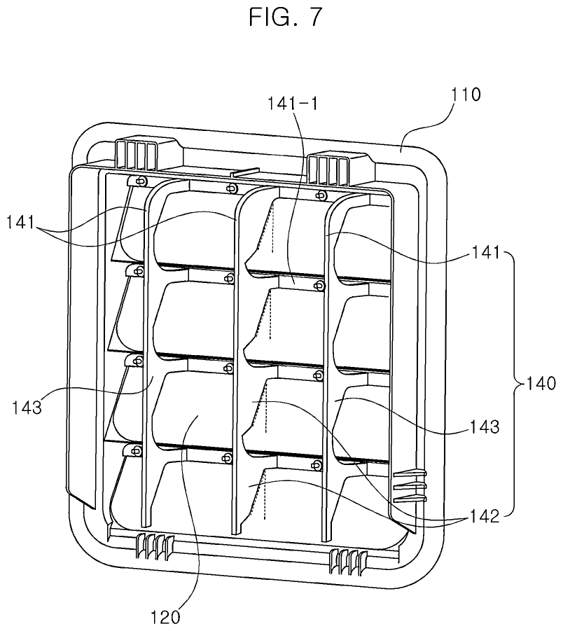

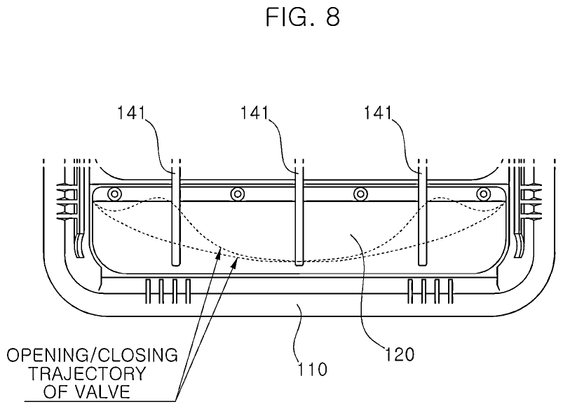

Next, with reference to FIGS. 7 to 9, in addition to the above-mentioned noise reduction part for reducing an abnormal collision noise, the extractor grille device may further include a valve opening guide part 140 for reducing strength by which the valve 120 collides with the grille housing 110.

The valve opening guide part 140 is a frame mounted inside the grille housing 110 and formed in a height direction of the grille housing 110 to restrict an opening angle of the valve 120. The valve opening guide part 140 includes frame portions 141 disposed in front of the valves 120, and guide portions (142, 143) protruding from the frame portions 141 toward the valve 120.

Therefore, when the valve 120 rotates toward the frame portion 141 so as to be opened, the opening angle is restricted by the guide portion, and the guide portion may protrude to be inclined, as illustrated.

As illustrated, the frame portions 141 may be provided as a plurality of frame portions 141 to divide the grille housing 110 in a width direction, and the guide portions may be respectively formed on the frame portions 141.

Further, the frame portions 141 may be coupled to a width direction frame (141-1), such that the frame portions 141 may be separated in the height direction. The guide portions may be respectively formed in regions in which the frame portions 141 are separated.

Further, the plurality of frame portions 141 may include central frame portions corresponding to a central portion in the width direction, and outer frame portions that are not the central frame portions. The outer frame portions are disposed between the central frame portions and the inner surface of the grille housing 110. In one embodiment, the guide portions may also include central guide portions 142 formed on the central frame portion, and outer guide portions 143 formed on the outer frame portions.

Therefore, the plurality of guide portions may be formed to have different protruding lengths depending on distances from the central portion in the width direction.

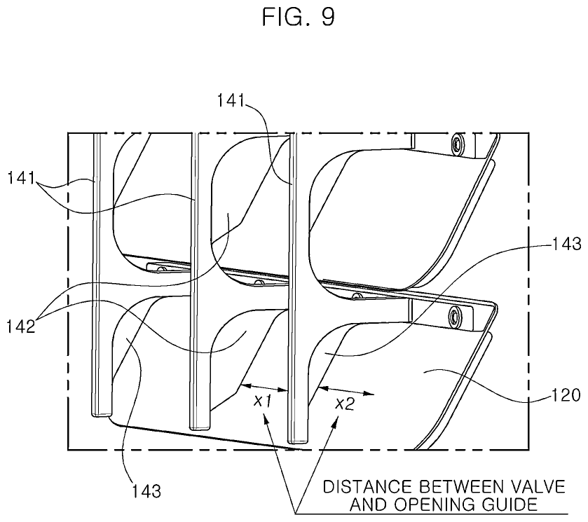

The protruding length of the central guide portion 142 may be longer than the protruding length of the outer guide portion 143, which results in a different distance between the valve and an opening guide illustrated in FIG. 9. Therefore, a distance x1 between the valve and the opening guide of the central guide portion 142 is shorter than a distance x2 between the valve and the opening guide of the outer guide portion 143.

The protruding length of the central guide portion 142 is relatively long, and the central guide portion 142 restricts the opening angle of the valve 120 corresponding to the central portion, such that the strength by which the valve 120 collides with the grille housing 110 at the central portion may be reduced. For example, the restricted opening angle may be 20°±5°.

As described above, the distance between the central guide portion 142 and the valve 120 and the distance between the outer guide portion 143 and the valve 120 are different from each other, such that the opening angle of the valve 120 at the central portion may be restricted, which makes it possible to expect the effect of reducing a noise by the difference in timing of closing the valves 120.

While the present disclosure has been described with reference to the exemplified drawings, it is obvious to those having ordinary skill in the art that the present disclosure is not limited to the aforementioned embodiments, and may be variously changed and modified without departing from the spirit and the scope of the present disclosure. Accordingly, the changed or modified examples belong to the claims of the present disclosure and the scope of the present disclosure should be interpreted on the basis of the appended claims.

What is claimed is:

1. An extractor grille device for a vehicle, which is used to discharge air in the vehicle to an outside, the extractor grille device comprising:
a grille housing mounted in the vehicle and including an opening portion;
a valve coupled to the grille housing and configured to rotate about a hinge shaft and open or close the opening portion; and
a noise reduction part coupled to and protruding from one surface of the grille housing around the opening portion so that the valve does not collide directly with the grille housing when the valve is opened or closed.

2. The extractor grille device of claim 1, wherein the noise reduction part is an elastic member having elasticity.

3. The extractor grille device of claim 2, wherein the elastic member is foamed polyurethane foam (PU-foam).

4. The extractor grille device of claim 2, wherein an elastic member groove is formed in the one surface of the grille housing around the opening portion, and the elastic member is inserted into the elastic member groove.

5. The extractor grille device of claim 2, further comprising:
a rib part coupled to the one surface of the grille housing around the elastic member and protruding from the one surface of the grille housing.

6. The extractor grille device of claim 4, wherein the elastic member is foamed polyurethane foam (PU-Foam), and holes are formed at two opposite ends of the elastic member groove.

7. The extractor grille device of claim 2, further comprising:
a valve opening guide part configured to restrict an opening angle of the valve when the valve is opened.

8. The extractor grille device of claim 7, wherein the valve opening guide part comprises:
a frame portion mounted in the opening portion inside the grille housing, formed in a height direction of the grille housing, and disposed forward of the valve; and
a guide portion protruding from the frame portion toward the valve.

9. The extractor grille device of claim 8, wherein the guide portion protrudes to be inclined.

10. The extractor grille device of claim 8, wherein the frame portion is provided as a plurality of frame portions including a central frame portion corresponding to a central portion in a width direction, and an outer frame portion formed between the central frame portion and an inner surface of the grille housing.

11. The extractor grille device of claim 10, wherein:
the guide portion is provided as a plurality of guide portions including a central guide portion formed on the central frame portion, and an outer guide portion formed on the outer frame portion, and
protruding lengths of the plurality of guide portions vary depending on distances from the central portion to the guide portions.

12. The extractor grille device of claim 11, wherein the protruding length of the central guide portion is longer than the protruding length of the outer guide portion.

13. The extractor grille device of claim 10, wherein:
the guide portion is provided as a plurality of guide portions including a central guide portion formed on the central frame portion, and an outer guide portion formed on the outer frame portion, and
distances between the plurality of guide portions and the valve vary depending on distances from the central frame portion to the plurality of guide portions.

14. The extractor grille device of claim 13, wherein a distance between the central guide portion and the valve is shorter than a distance between the outer guide portion and the valve.

15. The extractor grille device of claim 14, wherein the opening angle of the valve is restricted by interference with the central guide portion when the valve is fully opened.

16. An extractor grille device for discharging air from a vehicle to an outside of the vehicle, the extractor grille device comprising:
a grille housing mounted in the vehicle and including an opening portion;
a valve coupled to the grille housing and configured to rotate about a hinge shaft and open or close the opening portion; and
a valve opening guide part configured to restrict an opening angle of the valve when the valve is opened,
wherein the valve opening guide part comprises:
a frame portion mounted in the opening portion inside the grille housing, formed in a height direction of the grille housing, and disposed forward of the valve; and
a guide portion protruding from the frame portion toward the valve.

17. The extractor grille device of claim 16, wherein the frame portion is provided as a plurality of frame portions including a central frame portion corresponding to a central portion in a width direction, and an outer frame portion formed between the central frame portion and an inner surface of the grille housing, and
wherein the guide portion is provided as a plurality of guide portions including a central guide portion formed on the central frame portion, and an outer guide portion formed on the outer frame portion, and distances between the plurality of guide portions and the valve vary depending on distances from the central frame portion to the plurality of guide portions.

18. The extractor grille device of claim 17, wherein a distance between the central guide portion and the valve is shorter than a distance between the outer guide portion and the valve.

19. The extractor grille device of claim 18, wherein the opening angle of the valve is restricted by interference with the central guide portion when the valve is fully opened.

20. The extractor grille device of claim 16, further comprising:
a noise reduction part coupled to and protruding from one surface of the grille housing around the opening portion so that the valve does not collide directly with the grille housing when the valve is opened or closed.
